(19) United States
(12) Patent Application Publication
(10) Pub. No.: US 2018/0203944 A1
(43) Pub. Date: Jul. 19, 2018

(54) GRAPH DATABASES

(71) Applicants: Rycharde HAWKES, Bristol (GB); Eric DELIOT, Bristol (GB); Luis Miguel VAQUERO GONZALEZ, Bristol (GB); Lawrence WILCOCK, Bristol (GB); HEWLETT PACKARD ENTERPRISE DEVELOPMENT LP, Houston, TX (US)

(72) Inventors: Rycharde Hawkes, Bristol (GB); Eric Deliot, Bristol (GB); Luis Miguel Vaquero Gonzalez, Bristol (GB); Lawrence Wilcock, Bristol (GB)

(21) Appl. No.: 15/742,580

(22) PCT Filed: Jul. 7, 2015
(86) PCT No.: PCT/EP2015/065514

§ 371 Date: Jan. 8, 2018

(51) Int. Cl. G06F 17/30

(52) U.S. Cl. CPC G06F 17/30958; G06F 17/30368; G06F 17/30693; G06F 17/30604

(57) ABSTRACT

There is provided a non-transitory machine-readable storage medium encoded with instructions executable by a processor. The machine-readable storage medium comprises a graph database comprising first-level vertices and first-level edges, each first-level edge linking two first-level vertices, wherein each first-level vertex represents an entity and each first-level edge represents a relationship between two entities. The machine-readable storage medium further comprises instructions to: responsive to a generation of a result set for a query on the graph database, add a second-level vertex to the graph database, wherein the second-level vertex represents the result set of the query; and add a second-level edge to the graph database, wherein the second-level edge connects the second-level vertex to a first-level vertex.

### BACKGROUND

Graph databases represent entities as vertices and relationships between entities as edges which connect two vertices.

### BRIEF DESCRIPTION OF DRAWINGS

Examples will now be described, by way of non-limiting example, with reference to the accompanying drawings, in which:

FIG. 1 shows an example of an apparatus;

FIG. 2 shows an example of a non-transitory machine-readable storage medium;

FIG. 3 is a flowchart of an example of a method for representing a query result in a graph database;

FIG. 4 illustrates an example of an expanded graph database;

FIG. 5 is a flowchart of an example of a method for representing a further query result in a graph database;

FIG. 6 illustrates an example of an expanded graph database;

FIG. 7 is a flowchart of an example of a method for use in updating an expanded graph database;

FIG. 8 illustrates an example of an expanded graph database;

FIG. 9 is a flowchart of an example of a method for use in updating an expanded graph database;

FIG. 10 is a flowchart of an example of a method for use with an expanded graph database; and

FIG. 11 illustrates an example of an expanded graph database.

### DETAILED DESCRIPTION

Resolving a query on a graph database is achieved using the raw data items of the domain of the database. The querying process involves traversing vertices and edges in the graph database, and inspecting the properties of those vertices and edges. Properties of edges and vertices determine how the graph is traversed and which items are selected to be comprised in the result set of a given query.

An example graph database comprises a plurality of vertices, each of which represents the same type of entity (in this example, an employee). Each vertex may have associated properties, where a property is an item of information relating to the entity represented by that vertex. A property may comprise a value of an attribute of the entity. For example, an entity Ann in the graph database has a gender attribute with the value female, so the vertex representing Ann may have a “female” property. Friendship relationships between the employees are represented by edges. In this example Ann is friends with John and Sue, John is friends with Ann and Rick, Rick is friends with John and Dave, Dave is friends with Rick, and Sue is friends with Ann. Consequently, the graph database includes an edge connecting the Ann vertex and the John vertex, an edge connecting the Ann vertex and the Sue vertex, an edge connecting the Rick vertex and the Ann vertex, an edge connecting the Rick vertex and the John vertex, an edge connecting the Rick vertex and the John vertex, and an edge connecting the Rick vertex and the Dave vertex.

The process of querying a graph database, such as the example graph database described above, can be performed by a graph engine. A graph engine comprises a processing module to run computational processes against the dataset comprised in a graph database.

Many graph engines store the results of at least the latest-run queries as a result set in a cache which is completely separate from the graph database. Result sets which are not cached, or which have been cached for a certain amount of time, are deleted.

Extracting results from a cache, e.g. for input to a subsequent query, may involve inspecting all of the cached elements, and is therefore computationally intensive.

Furthermore, result sets held in the cache are not updated when changes occur to entities in the graph database, meaning that those result sets may no longer be valid at the time when it is wished to re-use them in resolving a subsequent query. Determining which cached result sets will be affected by any given change to an entity in the graph database is difficult because no links are maintained between cached results sets, or between raw data items and specific results sets. Also, any given entity may be included several times in the cache (since it may belong to several result sets), meaning that keeping track of the “belonging” relationships between entities and query results can involve performing full scans of the cache.

A technical challenge may exist with a cache of result sets, as cached result sets cannot themselves be queried using the graph engine. This means that a user cannot easily perform operations such as determining relationships between result sets, or refining a result set. Instead such operations are performed outside of the graph engine, as post-processing operations effected by a different processing module.

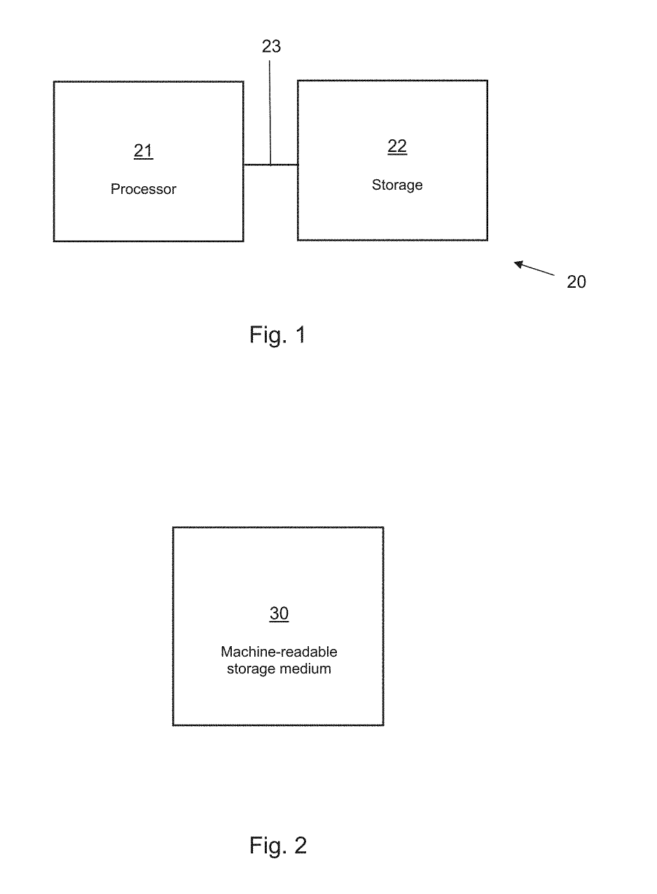

Examples disclosed herein provide technical solutions to these technical challenges. An example apparatus 20, e.g. for representing a result set of a query on a graph database by a sub-graph of the graph database, is illustrated in FIG. 1. The apparatus 20 comprises a processor 21 and a storage 22 coupled to the processor. The storage 22 can be coupled to the processor 21 by a wired or wireless communications link 23. The storage 22 stores a graph database comprising first-level vertices and first-level edges. Each first-level edge links two first-level vertices. Each first-level vertex represents an entity and each first-level edge represents a relationship between two entities. The apparatus further comprises an instruction set (not shown) of instructions executable by the processor 21. The instruction set when executed by a processor is to, responsive to a generation of a result set for a query on the graph database, add a second-level vertex to the graph database, and add a second-level edge (or multiple second-level edges) to the graph database. The second-level vertex represents the result set of the query and each second-level edge connects the second-level vertex to a first-level vertex. In some examples the instruction set is stored by the storage 22. In some examples the instruction set is stored by a storage other than the storage 22. In some examples the apparatus 20 comprises a graph engine.

FIG. 2 illustrates an example of a non-transitory machine-readable storage medium 30 encoded with instructions executable by a processor. The non-transitory machine-readable storage medium comprises a graph database. The graph database comprises first-level vertices and first-level edges. Each first-level edge links two first-level vertices. Each first-level vertex represents an entity and each first-level edge represents a relationship between two entities. In some examples at least one of the first-level vertices has at least one associated property. In some examples each first-level vertex is associated with a type. In some such examples the graph database is a multi-partite graph database, such that the first-level vertices are partitionable into two or more independent sets based on the type of the first-level vertices.

The instructions encoded by the machine-readable storage medium 30 comprise instructions which, when executed by a processor, cause the processor to: responsive to a generation of a result set for a query on the graph database, add a second-level vertex to the graph database; and add a second-level edge (or multiple second-level edges) to the graph database. The second-level vertex represents the result set of the query and each second-level edge connects the second-level vertex to a first-level vertex. In some examples the non-transitory machine-readable storage medium 30 comprises the storage 22 of the apparatus 20 shown in FIG. 1.

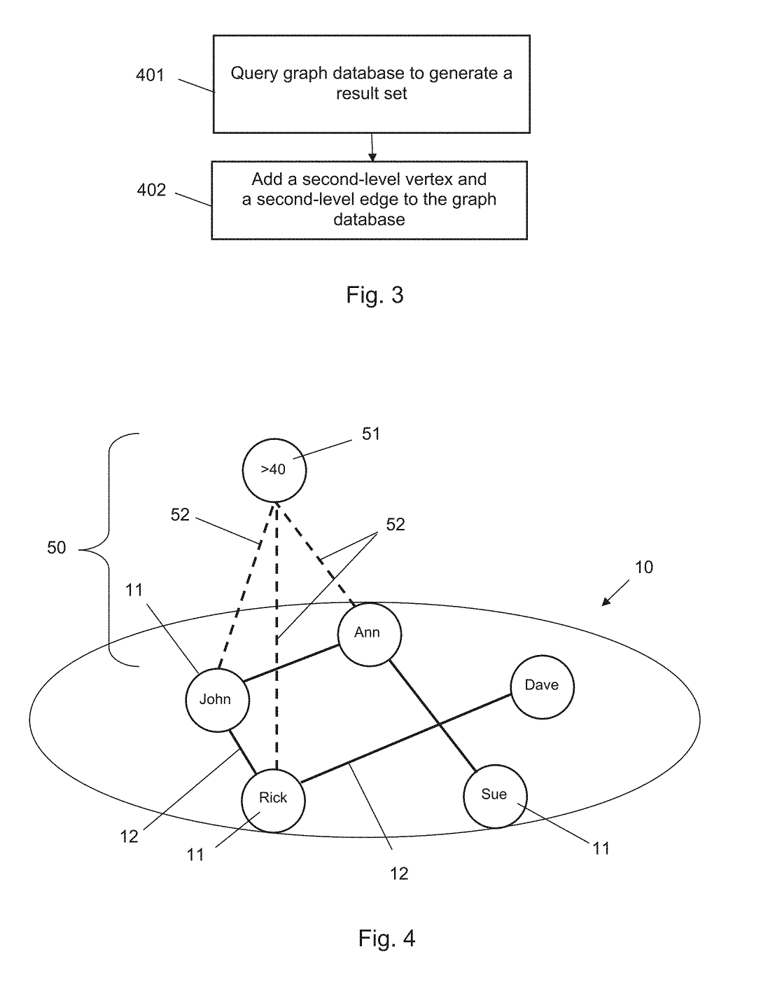

FIG. 3 illustrates an example of a method in which a result set of a query on a graph database is represented by a sub-graph of the graph database. The method is performed in relation to a graph database comprising first-level vertices and first-level edges, each first-level edge linking two first-level vertices, wherein each first-level vertex represents an entity and each first-level edge represents a relationship between two entities. In some examples at least one of the first-level vertices has at least one associated property. In some examples each first-level vertex is associated with a type. In some such examples the graph database is a multi-partite graph database, such that the first-level vertices are partitionable into two or more independent sets based on the type of the first-level vertices. In some examples the instructions, e.g. the instructions encoded by the non-transitory machine-readable storage medium 30, or the instructions comprised in the instruction set of the apparatus 20, when executed by a processor cause the processor to implement the method of FIG. 3.

In a first block, 401, the graph database is queried to generate a result set, e.g. by submitting a query formulated in a query language to a graph engine of the graph database. Any suitable query language can be used to formulate the query.

In a second block, 402, responsive to the generation of the result set, a second-level vertex and a second-level edge (or multiple second-level edges) are added to the graph database, e.g. by a graph engine of the graph database. In some examples the instructions, e.g. the instructions encoded by the non-transitory machine-readable storage medium 30, or the instructions comprised in the instruction set of the apparatus 20, when executed by a processor cause the processor to add the second level vertices and the second level edges to the graph database. The added second-level vertex represents the result set of the query. Each second-level edge connects the added second-level vertex to a first-level vertex. In some examples a naming scheme is used to identify second-level vertices in the graph database. In some such examples each second-level vertex is associated with a name which comprises a hash encoding of the query parameters and operators of the query which generated the result set represented by the named second-level vertex.

FIG. 4 illustrates this process with respect to the example graph database described above in paragraph 15. The vertices of the underlying graph database 10, which represent entities, comprise first-level vertices 11. The edges in the underlying graph database 10, which connect pairs of first-level vertices, comprise first level-edges 12 (shown by solid lines in FIG. 4). The query in this example seeks entities which are connected by friendship relationships and which have an age attribute value less than 40, and the result set comprises Ann, John and Rick. In this example the query is formulated in Dataflow Query Language as: friends.filter(age>40). However; in other examples the query can be formulated in a different, non-dataflow based query language such as Cypher.

As can be seen from FIG. 4, the underlying graph 10 is grown vertically by the addition of a sub-graph 50 representing the results of the query to create an expanded graph (e.g., by graph engine of graph database). In some examples the instructions, e.g. the instructions encoded by the non-transitory machine-readable storage medium 30, or the instructions comprised in the instruction set of the apparatus 20, when executed by a processor cause the processor to add the sub-graph. The sub-graph 50 comprises a second-level vertex 51, which represents the result set of the query. The sub-graph 50 also comprises second-level edges 52 (shown by dashed lines in FIG. 4), which connect the first-level vertices representing the entities comprised in the result set of the query to the second-level vertex. In other words, the second-level vertex 51 represents the aggregation of entities in the result set. The second-level edges 52 represent containment relationships, i.e. the entity represented by a first-level vertex 11 connected to a second-level vertex 51 by a second-level edge 52 is contained in the result set represented by that second-level vertex. In some examples the second-level edges 52 represent bi-directional containment relationships, which in a first direction comprise a “contained-in” relationship and in a second direction comprise a “contains” relationship.

Thus, in the examples, the result set of a query is added to the graph database itself rather than being stored in a separate cache. This enables previous result sets to be easily re-used by a graph engine as inputs to further queries.

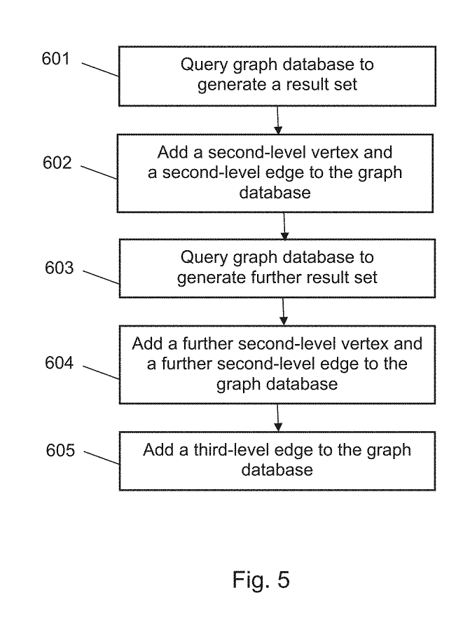

FIG. 5 illustrates an example of a method of querying an expanded graph, e.g. an expanded graph created by the example method of FIG. 3. In some examples the instructions referred to above in relation to FIGS. 1 and 2, e.g. the instructions encoded by the non-transitory machine-readable storage medium 30, or the instructions comprised in the instruction set of the apparatus 20, when executed by a processor cause the processor to implement the method of FIG. 5.

Blocks 601 and 602 are performed as described above in relation to blocks 401 and 402 of FIG. 3, resulting in the creation of an expanded graph at least one second-level vertex and at least one second level edge.

In block 603, the graph database is queried again (i.e. a further query is submitted to the graph engine of the graph database), leading to the generation of a further result set. In some examples the further query is formulated using the same query language as the first query. Any suitable query language can be used to formulate the further query. In some examples block 603 is performed in the same manner as block 601.

In block 604, responsive to the generation of the further result set, a further second-level vertex and a further second-level edge (or multiple further-second level edges) are added to the graph database, e.g. by the graph engine. The added further second-level vertex represents the result set of the further query. Each further second-level edge connects the added further second-level vertex to a first-level vertex. In some examples block 604 is performed in the same manner as block 602.

Then, in block 605, a third-level edge (or multiple third-level edges) are added to the graph database. Each third-level edge connects the added further second-level vertex to a second-level vertex already present in the graph database.

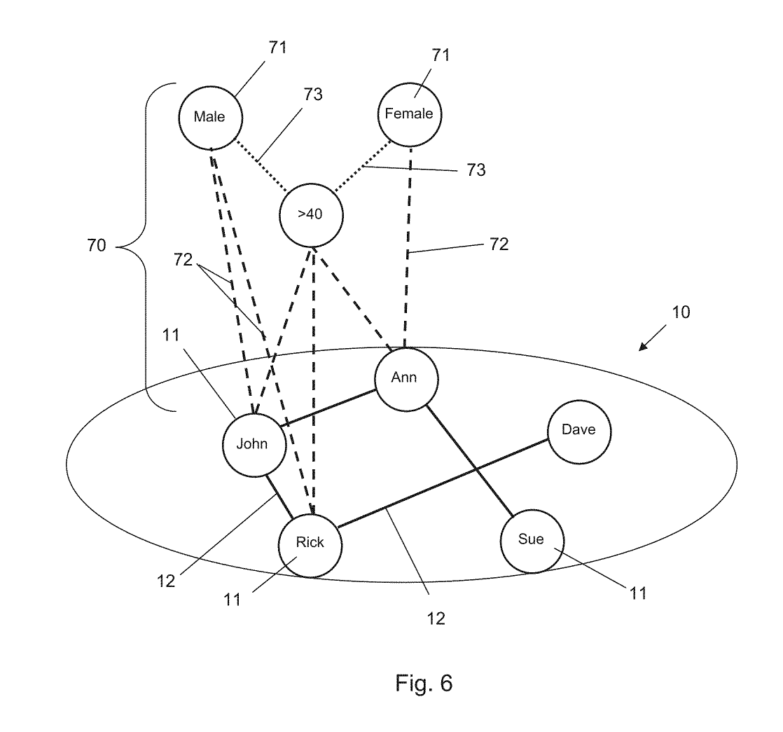

FIG. 6 illustrates this process with respect to the example expanded graph FIG. 4. The further query in this example seeks to filter the results of the previous query (i.e. entities which are connected by friendship relationships and which have an age attribute value less than 40) by gender. Thus, the result set of the previous query (i.e. friends.filter(age>40)) is used as an input to the further query (i.e. the inputs to the further query comprise the first-level vertices 11 and the second level vertex 51). In this example the query is formulated in Dataflow Query Language as: friends.filter(age>40).groupBy(gender). However; in other examples the query can be formulated in a different, non-dataflow based query language such as Cypher.

Two result sets are generated by the further query: a Male result set which comprises John and Rick, and a Female result set which comprises Ann. Two further second-level vertices 71 have been added to the sub-graph 50 to create an expanded sub-graph 70. The further second-level vertices 71 represent the Male result set and the Female result set. As with the second-level vertex 51 representing the previous query, each further second-level vertex 71 is connected to the first-level vertices representing entities comprised in the result set which that further second-level vertex represents, by further second-level edges 72. The further-second level edges 72 represent containment relationships. In some examples the further-second level edges 72 represent bi-directional containment relationships.

The further second-level vertices 71 are also linked to the second level vertex 51 by a parenthood relationship. This is represented in the sub-graph 70 by means of a third-level edge 73 connecting each further second-level vertex 71 to the second-level vertex 51. In some examples the instructions, e.g. the instructions encoded by the non-transitory machine-readable storage medium 30, the graph engine of the graph database, or the instructions comprised in the instruction set of the apparatus 20, when executed by a processor cause the processor to connect the third-level edges to the second level-vertices. The third-level edges 73 are shown by dotted lines in FIG. 6. In this example the third-level edges represent parent-child relationships. In some examples third-level edges can comprise correlation relationships, where a third-level edge which represents a correlation relationship links two result sets that are highly correlated.

In some examples the process represented by blocks 603-605 of FIG. 5 is performed in respect of all further queries on the graph database. The resulting expanded graph comprises a flat underlying graph (e.g. the graph 10) containing all of the raw data items (i.e. which represent the entities being analysed), which has been vertically expanded by the addition of vertical branches representing the result sets of all of the queries that have ever been performed on the graph database.

It is expected that in many situations users will explore a graph database in similar manners. For example, users from a particular geographical region may often apply a filter so that they see results from that region and do not see results from other regions. In such situations it will often be possible to reuse query results already represented by second-level vertices in the graph database. Thus, in the examples, resolving a query does not involve recreating previously computed result sets, nor does it involve performing a O(N) comparison in respect of all of the results in a cache (which contains N elements) to see if a given result is held in that cache. Instead, in the examples, a graph engine checks if a prior computation exists that may be used as an input to a newly received query by analysing the expanded graph. Analysing the expanded graph is significantly less computationally intensive than recomputing previous result sets and/or searching a cache of previous result sets.

A further effect of adding query result sets to a graph database in the form of second-level vertices and second-level edges, as is done by the examples, is that the process of updating stored result sets to account for a change to an entity represented in the graph database is simplified as compared to prior art cache-updating processes.

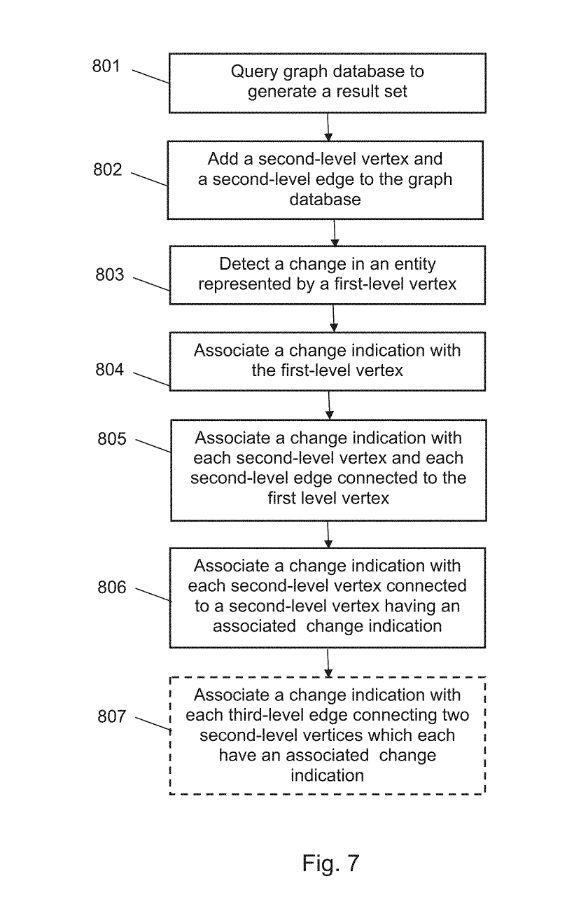

FIG. 7 illustrates an example of a method for use in updating an expanded graph, e.g. an expanded graph created by the example method of FIG. 3 or by the example method of FIG. 5. In some examples the instructions referred to above in relation to FIGS. 1 and 2, e.g. the instructions encoded by the non-transitory machine-readable storage medium 30, or the instructions comprised in the instruction set of the apparatus 20, when executed by a processor cause the processor to implement the method of FIG. 7.

Blocks 801 and 802 are performed as described above in relation to blocks 401 and 402 of FIG. 3, resulting in the creation of an expanded graph comprising at least one second-level vertex and at least one second level edge.

In block 803 a change in an entity represented by a first-level vertex is detected, e.g. by the graph engine. In some examples the instructions, e.g. the instructions encoded by the non-transitory machine-readable storage medium 30, or the instructions comprised in the instruction set of the apparatus 20, when executed by a processor cause the processor to detect the change. In some examples the change comprises the addition of the entity to the graph database (and therefore the addition to the graph of a first-level vertex representing the entity). In some examples the change comprises the removal of the entity from the graph database (and therefore the deletion from the graph of a first-level vertex representing the entity). In some examples the change comprises a change in the value of an attribute of the entity (and therefore a change in the value of a property of a first-level vertex representing the entity).

In some examples detecting a change in an entity comprises the graph engine detecting that new information has been added to the graph database. In some such examples the new information comprises information about changes, additions, and/or deletions which have occurred in respect of entities in the graph database. In some examples detecting a change in an entity comprises the graph engine performing a full scan of the graph database and comparing the results to the results of a previously performed scan. In a particular example, the graph engine comprises a data ingestion component which is responsible for creating and updating vertices in the graph, using attributes of the entities represented by each given vertex. The ingestion component is to compare the current attributes of an entity with the corresponding vertex in the graph, and detect a change if at least one attribute is found to be different. In a similar manner the ingestion component may detect that a vertex no longer corresponds to an entity, or that a new entity has been created which does not have a corresponding vertex in the graph.

In some examples, the graph engine includes rules to define a first set of attributes which are deemed to cause a change to an entity (for the purposes of the method of FIG. 7) if the value of one of those attributes changes, and a second set of attributes which are deemed not to cause a change to an entity (for the purposes of FIG. 7) if the value of one of those attributes changes. In such examples, changes to attributes which are included in the first set can cause vertices and edges in the graph to be flagged as dirty (e.g. by the association of a change indication) and/or recomputed, whereas changes to attributes which are included in the second set cannot cause vertices and edges in the graph to be flagged as dirty and/or recomputed. In some examples the particular attributes included in the first set and the second set depends on the context of a query. For example, an entity representing a virtual machine (VM) may contain an attribute that reflects current CPU utilisation. The value of this attribute will change very frequently, meaning that recomputing the graph in response to each change of a CPU utilisation attribute of a VM entity would involve significant computational resource. Attributes that represent measured metrics (e.g. the CPU utilisation attribute) will not be relevant to certain types of queries, and for these query types the CPU utilisation attribute and other attributes representing measured metrics can be included in the second set of attributes. For other query types, the attributes representing measured metrics may be included in the first set of attributes. Providing rules to define which attributes are deemed to cause a change to an entity can avoid a significant amount of recomputation.

Responsive to a change in an entity represented by a first-level vertex, a change indication is associated with the first-level vertex which represents the changed entity (block 804). In some examples the instructions, e.g. the instructions encoded by the non-transitory machine-readable storage medium 30, a graph engine, or the instructions comprised in the instruction set of the apparatus 20, when executed by a processor cause the processor to associate the change indication with the first-level vertex (or other vertex). A change indication is also associated with each second-level vertex connected to the first-level vertex representing the changed entity, and with each second-level edge connected to the first-level vertex representing the changed entity (block 805). Then, in block 806, a change indication is associated with each second-level vertex connected to a second-level vertex to which a change indication has been associated in block 805. In some examples (i.e. examples in which at least one pair of second-level vertices which have had change indications associated with them are connected by a third-level edge) a further block 807 is performed, in which a change indication is also associated with each third-level edge which connects two second-level vertices which have each had a change indication associated with them in block 804 or block 805. In some examples the change indications comprise flags.

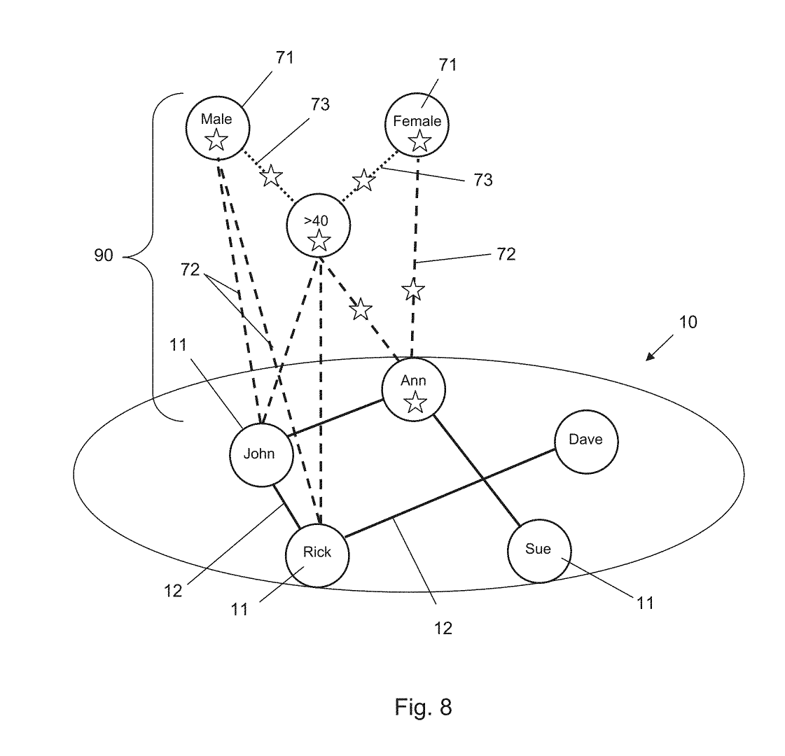

FIG. 8 illustrates the process of FIG. 7 with respect to the example expanded graph of FIG. 6. In this example, an attribute of the entity “Ann” changes, and this change is detected as described above in relation to block 803 of FIG. 7. Responsive to this change, the second-level edges 72 which are connected to the first-level vertex 11 representing Ann are followed (e.g. by the graph engine). The second-level vertices 71 found by following the second-level edges 72 connected to Ann are then flagged as “dirty” (i.e. a change indication is associated with the second-level vertices connected to Ann by second-level edges). In FIG. 8 the dirty edges and vertices (i.e. those which have associated change indications) are marked by stars. In some examples, including the particular example shown in FIG. 8, the second-level edges 72 connected to a dirty first-level vertex are also flagged as dirty. Then, third-level edges 73 connected to dirty second-level vertices 71 are followed, and the second-level vertices to which the followed third-level edges are flagged as dirty. In some examples, including the particular example shown in FIG. 8, the third-level edges 73 connected to two dirty second-level vertices 71 are also flagged as dirty. Thus, the “dirty part” is propagated along the containment and parenthood relationships associated with a changed entity and the queries in which the changed entity is involved. Consequently, the “dirty part” is restricted to a sub-graph comprising vertices and edges that are directly affected by the change to the Ann entity. Restricting the scope of the dirty part in this manner can speed up the subsequent recalculation of the dirty edges and vertices.

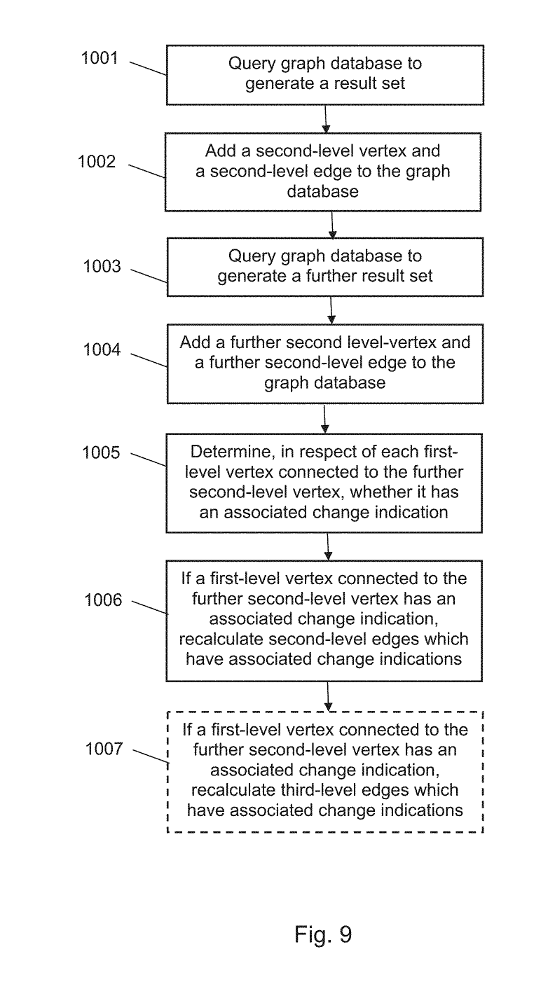

FIG. 9 illustrates an example of a method for use in updating an expanded graph, e.g. an expanded graph created by the example method of FIG. 3 or by the example method of FIG. 5. In some examples the instructions referred to above in relation to FIGS. 1 and 2, e.g. the instructions encoded by the non-transitory machine-readable storage medium 30, or the instructions comprised in the instruction set of the apparatus 20, when implemented by a processor cause the processor to implement the method of FIG. 9.

Blocks 1001 to 1004 are performed as described above in relation to blocks 601 to 604 of FIG. 5, resulting in the creation of an expanded graph comprising at least one second-level vertex and at least one second level edge. In block 1005 it is determined, e.g. by a graph engine of the graph database, whether a first-level vertex connected to the further second-level vertex has an associated change indication. This determination is performed in respect of each first-level vertex to which the further second-level vertex is connected.

If, in block 1005, it is determined that a first-level vertex connected to the further second-level vertex has an associated change indication, then all second-level edges, which are connected to the first-level vertex which is determined to have an associated change indication and which themselves have associated change indications, are recalculated (e.g. by the graph engine). In some examples (i.e. examples in which the graph database comprises at least one third-level edge) a further block 1007 is performed. In block 1007, if it has been determined (i.e. in block 1005) that a first-level vertex connected to the further second-level vertex has an associated change indication, then all third-level edges which have associated change indications, and which are connected to a second-level vertex which is itself connected to the first-level vertex determined to have an associated change indication, are recalculated.

Thus, in the example of FIG. 8, if a further query is received after the vertices and edges directly affected by the change to the Ann entity have been flagged as dirty, the result set generated by the graph engine will be added to the graph as a new second-level vertex and associated second-level edge(s), in the manner described above in relation to FIGS. 5 and 6. Then, the graph engine will determine whether any of the first-level vertices which are connected to the new second-level vertex are flagged as dirty. In the example of FIG. 8, a positive determination will be made if the new-second level vertex is connected to the “Ann” first-level vertex.

In the case that the new second-level vertex is connected to the dirty Ann first-level vertex, this triggers the graph engine to recalculate the entire “dirty part” of the graph which relates to the change to the Ann entity. A graph may contain several independent “dirty parts”, resulting from changes to multiple different entities. However; whilst dirty parts propagating from entities comprised in the result set of a newly-received query are recalculated, other dirty parts are not recalculated until a query is received which generates a result set including an entity in a given dirty part.

In the case that the new second-level vertex is not connected to the dirty Ann first-level vertex (i.e. it is connected to “clean” first-level vertices which do not have associated change indications, which in this example is any of the first-level vertices apart from Ann, and is not connected to any “dirty” first-level vertices), no recalculation is performed.

The process of FIG. 9 can therefore be seen as a “lazy” approach to updating stored result sets, because none of the graph elements are invalidated or recalculated until those elements are needed to resolve a particular query. “Eager” approaches are also possible, in which the recalculation of a dirty part is performed as soon as a change to an entity has been detected and the resulting dirty part identified. An eager approach can minimise the latency experienced by a client interacting with the graph database.

A further effect of adding query result sets to a graph database in the form of second-level vertices and second-level edges, as is done by the examples, is that relationships between result sets can be easily identified by navigating across the graph. In the examples, determining whether two-result sets are related involves navigating from a first second-level vertex to a second second-level vertex, via the underlying graph of first-level vertices.

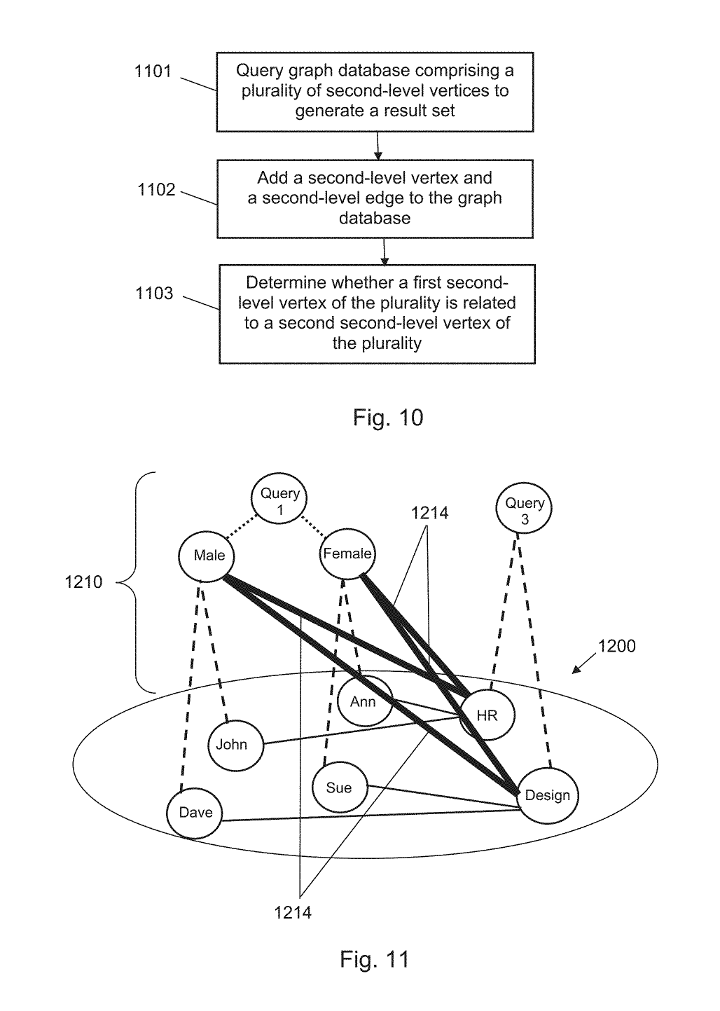

FIG. 10 illustrates an example of a method, e.g. for determining whether a first result set represented in an expanded graph is related to a second result set in the expanded graph. The expanded graph may be, e.g., an expanded graph created by the example method of FIG. 3 or by the example method of FIG. 5. In some examples the instructions referred to above in relation to FIGS. 1 and 2, e.g. the instructions encoded by the non-transitory machine-readable storage medium 30, or the instructions comprised in the instruction set of the apparatus 20, when executed by a processor cause the processor to implement the method of FIG. 10.

Blocks 1101 and 1102 are performed as described above in relation to blocks 401 and 402 of FIG. 3. Blocks 1101 and 1102 may be repeated multiple times. The graph database on which the example method of FIG. 10 is performed comprises a plurality of second-level vertices, each of which is connected to at least one first-level vertex by a second-level edge. In block 1103 it is determined (e.g. by a graph engine of the graph database) whether a first second level vertex of the plurality is related to a second second-level vertex of the plurality. The determination of block 1103 is performed by determining whether a path exists between the first second-level vertex and the second second-level vertex, using any suitable path determination technique. In some examples the determination of block 1103 involves finding the shortest path between the first second-level vertex and the second-level vertex. In some examples determining whether a path exists between the first second-level vertex and the second second-level vertex comprises determining whether a path exists between the first second-level vertex and a first-level vertex which is connected to the second second-level vertex.

FIG. 11 illustrates the process of FIG. 7 with respect to an example expanded graph database comprising an underlying graph 1200 and a sub-graph of query result sets 1210. The example expanded graph comprises four first-level vertices of a first type (John, Dave, Sue, Ann), each of which represents an employee, and two first-level vertices of a second type (HR, Design), each of which represents a department. The first-level edges (shown by the thin solid lines) represent containment relationships. Thus, it can be seen from the graph database 10 that Ann and John belong to the HR department and Sue and Dave belong to the Design department.

The sub-graph 1210 comprises four second-level vertices, representing the result sets of a first query (Query 1), a refinement of that query (M and F), and a further query (Query 3). The result set Query 1 comprises all employees, the result set M comprises all male employees, the result set F comprises all female employees, and the result set Query 3 comprises all departments. If a user wishes to determine whether a relationship exists between M and Query 3 (i.e. whether the Design department contains any male employees), this determination can be made by determining whether a path exists between the M vertex and the Query 3 vertex. In practice, this may comprise determining whether a path exists between the M vertex and a first-level vertex to which the Query 3 vertex is connected.

It can be seen from FIG. 11 that the M vertex is indirectly connected to the Query 3 vertex via the Dave and Design vertices, so a path does exist. In the example of FIG. 11 one such path exists, but in other examples there could be multiple paths. It is therefore true that the Design department contains a male employee. This relationship between the result set M and the result set Query 3 is shown in FIG. 11 by a thick solid line 1214. The other relationships between the result sets in the sub-graph 1210 are also shown, in the same manner. It can be seen that in each case, the thick line representing the relationship is a direct version of an indirect path formed by first-level edges and second-level edges.

Examples in the present disclosure can be provided as methods, systems or machine readable instructions. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules or engines of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operation steps to produce computer-implemented processing, thus the instructions executed on the computer or other programmable devices provide a step for realizing functions specified by flow(s) in the flow charts and/or block(s) in the block diagrams.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A non-transitory machine-readable storage medium encoded with instructions executable by a processor, the machine-readable storage medium comprising:
a graph database comprising first-level vertices and first-level edges, each first-level edge linking two first-level vertices, wherein each first-level vertex represents an entity and each first-level edge represents a relationship between two entities; and
instructions to:
responsive to a generation of a result set for a query on the graph database, add a second-level vertex to the graph database, wherein the second-level vertex represents the result set of the query; and add a second-level edge to the graph database, wherein the second-level edge connects the second-level vertex to a first-level vertex.

2. A non-transitory machine-readable storage medium in accordance with claim 1, wherein each second-level edge connects a second-level vertex to a first-level vertex which represents an entity comprised in the result set represented by the connected second-level vertex.

3. A non-transitory machine-readable storage medium in accordance with claim 1, wherein each first-level vertex is associated with a type, and wherein the graph database is a multi-partite graph database, such that the first-level vertices are partitionable into two or more independent sets based on the type of the first-level vertices.

4. A non-transitory machine-readable storage medium in accordance with claim 1, wherein each second-level edge represents a containment relationship.

5. A non-transitory machine-readable storage medium in accordance with claim 1, further comprising instructions to:
responsive to a generation of a further result set, for a further query on the graph database, add a further second-level vertex to the graph database, wherein the further second-level vertex represents the further result set; add a further second-level edges to the graph database, wherein the further second-level edge connects the further second-level vertex to a first-level vertex; and add a third-level edges to the graph database, wherein the third-level edge connects the further second-level vertex to a second-level vertex.

6. A non-transitory machine-readable storage medium in accordance with claim 5, wherein each third-level edge represents a parent-child relationship.

7. A non-transitory machine-readable storage medium in accordance with claim 5, wherein the inputs to the further query comprise the first-level vertices and the second-level vertex.

8. A non-transitory machine-readable storage medium in accordance with claim 1, further comprising instructions to:
responsive to a change to an entity represented by a first-level vertex:
associate a change indication with the first-level vertex representing the changed entity;
associate a change indication with each second-level vertex connected, by a second-level edge, to the first-level vertex representing the changed entity, and with each second-level edge connected to the first-level vertex representing the changed entity; and
associate a change indication with each second-level vertex connected, by a third-level edge, to a second-level vertex having an associated change indication.

9. A non-transitory machine-readable storage medium in accordance with claim 8, further comprising instructions to associate a change indication with each third-level edge connecting two second-level vertices which each have an associated change indication.

10. A non-transitory machine-readable storage medium in accordance with claim 8, wherein the change to an entity comprises one of: addition of the entity to the graph database; removal of the entity from the graph database; a change in the value of an attribute of the entity.

11. A non-transitory machine-readable storage medium in accordance with claim 8, further comprising instructions to:
responsive to a generation of a further result set, for a further query on the graph database:
add a further second-level vertex to the graph database, wherein the further second-level vertex represents a result set of the further query;
add a further second-level edge to the graph database, wherein the further second-level edge connects the further second-level vertex to a first-level vertex;
determine, in respect of each first-level vertex connected to the further second-level vertex, whether that first-level vertex has an associated change indication;
if a first-level vertex connected to the further second-level vertex has an associated change indication, recalculate second-level edges which have associated change indications based on the changed entity.

12. A non-transitory machine-readable storage medium in accordance with claim 11, wherein the graph database comprises at least one third-level edge connecting two second-level vertices, further comprising instructions to:
responsive to the determination, in respect of each first-level vertex connected to the further second-level vertex, whether that first-level vertex has an associated change indication, if a first-level vertex connected to the further second-level vertex has an associated change indication, recalculate third-level edges which have associated change indications based on the changed entity.

13. A non-transitory machine-readable storage medium in accordance with claim 1, wherein the graph database comprises a plurality of second-level vertices, each of which is connected to at least one first-level vertex by a second-level edge, the machine-readable storage medium further comprising instructions to:
determine whether a first second-level vertex of the plurality is related to a second second-level vertex of the plurality by determining whether a path exists between the first second-level vertex and the second second-level vertex.

14. A method, performed in relation to a graph database comprising first-level vertices and first-level edges, each first-level edge linking two first-level vertices, wherein each first-level vertex represents an entity and each first-level edge represents a relationship between two entities, the method comprising:
querying the graph database to generate a result set;
responsive to the generation of the result set, adding a second-level vertex to the graph database, wherein the second-level vertex represents the result set of the query; and adding a second-level edge to the graph database, wherein the second-level edge connects the second-level vertex to a first-level vertex.

15. Apparatus comprising:
a processor;
a storage coupled to the processor, storing a graph database comprising first-level vertices and first-level edges, each first-level edge linking two first-level vertices, wherein each first-level vertex represents an entity and each first-level edge represents a relationship between two entities; and
an instruction set to cooperate with the processor and the storage to:
responsive to a generation of a result set for a query on the graph database, add a second-level vertex to the graph database, wherein the second-level vertex represents the result set of the query; and add a second-level edge to the graph database, wherein the second-level edge connects the second-level vertex to a first-level vertex.
